(19) United States
(12) Patent Application Publication
(10) Pub. No.: US 2017/0075593 A1
(43) Pub. Date: Mar. 16, 2017

(54) SYSTEM AND METHOD FOR COUNTER FLUSH FREQUENCY

(71) Applicant: SanDisk Technologies Inc., Plano, TX (US)

(72) Inventors: Hyoseong Kim, San Jose, CA (US); Yichao Huang, San Jose, CA (US)

(73) Assignee: SanDisk Technologies Inc., Plano, TX (US)

(21) Appl. No.: 14/852,266

(22) Filed: Sep. 11, 2015

(51) Int. Cl. G06F 3/06

(52) U.S. Cl. CPC G06F 3/0616; G06F 3/064; G06F 3/0653; G06F 3/0679

(57) ABSTRACT

Apparatus and method for determining when to save values of read counters are disclosed. Read counters store values that indicate the number of reads in respective blocks of a memory device. The values of the read counters may be stored in volatile memory, and may be periodically stored to non-volatile memory. The frequency at which the values of the read counters are stored to non-volatile memory may be dependent on the read disturb effect. One measure of the read disturb effect may be based on the characteristics of the respective blocks of the memory device, such as whether the respective block is open/closed, has on-chip copy, and whether the read is to a boundary wordline.

### TECHNICAL FIELD

This application relates generally to memory devices. More specifically, this application relates to determining a frequency at which to save a value of a counter that monitors activity in a block of memory.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A memory device may comprise a memory device controller and memory. The memory may be composed of multiple blocks, with each block being composed of multiple cells, such as NAND flash memory cells. The memory device controller may program data into the cells within a respective block and may read data from the cells of the respective block.

The data programmed in the memory is susceptible to corruption due to various factors. For example, data in the memory may be corrupted simply by ordinary read, program and erase sequences, where memory cells in physical proximity to those that are subject to a read, program or erase action may be unintentionally stressed to a point where stored charge levels are altered enough such that bit errors are induced in those memory cells. With respect to read operations, read stress is induced not only on the wordline being read but also when the read voltage is applied to other wordlines in a physical memory block. The stress on wordlines not being read is sometimes referred to as a read disturb effect. If a block is being read unevenly, some pages may be corrupted without being read. Error correction codes (ECC) are typically implemented when storing and retrieving data in order to improve the chance that the data can be read from flash memory without errors. When the corruption is beyond the ability of the ECC algorithm to repair, however, the system may completely lose the data in those pages.

In order to prevent the read disturb problem, the memory device controller may perform a read scrub process at regular intervals. In particular, the memory device controller monitors the number of reads to a block of memory since the last erase, and when the number of reads exceeds a threshold, copies the data from the block of memory into a new block.

### BRIEF DESCRIPTION OF THE DRAWINGS

The system may be better understood with reference to the following drawings and description. In the figures, like reference numerals designate corresponding parts throughout the different views.

FIG. 1A is a block diagram of an example non-volatile memory device.

FIG. 1B is a block diagram illustrating an exemplary storage circuitry.

FIG. 1C is a block diagram illustrating a hierarchical storage system.

FIG. 2A is a block diagram illustrating exemplary components of a controller of a non-volatile memory device.

FIG. 2B is a block diagram illustrating exemplary components of a non-volatile memory of a non-volatile memory storage system.

FIG. 3 illustrates a first flow chart for determining whether to save the read count to non-volatile memory.

FIG. 4 illustrates a second flow chart for determining whether to save the read count to non-volatile memory.

FIG. 5 illustrates a flow chart for determining whether to process a flush read counter message.

FIG. 6 illustrates a table of read scrub threshold versus the rate.

### DETAILED DESCRIPTION

As discussed above, the memory device may include a memory device controller and memory (e.g., one or more blocks of memory). The memory device controller may monitor one or more activities in the memory, such as activities in the blocks of memory. In one embodiment, the memory device controller may monitor reads from a respective block. In particular, the memory device controller may seek to prevent the read disturb problem by monitoring one or more types of reads for the respective block. As one example, the memory device controller may include a cumulative counter for the respective block in which the memory device controller monitors the reads to any part of the respective block since the last erase for the respective block. Specifically, the respective block may be composed of a plurality of pages. The memory device controller may maintain the value of the cumulative counter for the respective block, with the value indicative of the number of reads to any page within the respective block. For example, in response to a read to one of the pages in the respective block, the cumulative counter is incremented by 1. Instead of a cumulative counter being assigned to a single block, in an alternate embodiment, the counter for the cumulative number of reads to the block may also be generalized to the case when the wordlines of a block are subdivided into a number of zones of contiguous wordlines. For example, in addition to the special treatment for the boundary wordlines, the memory device may use more than one counter for the block's cumulative counts. An example of cumulative counters and boundary WL counters are disclosed in U.S. application Ser. No. 14/526,870, entitled “Read Scrub with Adaptive Counter Management”, incorporated by reference herein in its entirety.

In this regard, the memory device may keep one counter for each block. Each read applied to the block will result in the increment of the counter once, triggering a block copy if the count exceeds the read endurance threshold. Memory read disturb specifications are typically in terms of number of reads allowed per page. With the block counter, the memory device has no way to tell the physical location of the read stress within the block, so it has to be limited by the worst case, which leads to potential over-scrubbing. Another possible drawback of this method is that it does not consider the difference between open block (where a block is less than fully written) read disturb and closed block read disturb. Regardless of whether the block is open or closed, the counter will track the exact same way. The read endurance will be bounded by the worst case usage.

As another example, the memory device controller may include a boundary wordline (WL) counter for the respective block. In particular, a block that has all of its pages written is designated as a closed block. Conversely, a block that does not have all of its pages written (and still has some of its pages open for writing to) is designated as an open block. For a respective open block, the memory device controller may maintain the boundary WL counter for the respective open block, with the value indicative of the number of reads to the boundary WL. In particular, wordlines are typically written sequentially starting from one end, such as with the source end with WL0, and working through to WLn on the drain side. As such, a partially written, or open, block will have a boundary wordline, or wordlines, as the last written wordline (or set of wordlines) in the sequence.

Non-written wordlines are disturbed by the memory reading the written wordlines in the same open blocks. For boundary wordlines, the Yupin effect is not fully established before the next wordline gets programmed. These boundary wordlines may show worse condition than other wordlines in the block. It can thus be useful to distinguish the boundary wordline read stress.

Thus, to identify the risky block and flag them for read scrub relocation in time, a boundary wordline (WL) and cumulative WL counters (e.g., firmware based counters) may be used for open blocks to track the read stress and verify against the thresholds to determine when to copy the data to a new block. These counters can be firmware based and maintained by the controller in RAM, non-volatile memory, or some combination of these. For example, the firmware can create a structure for the read counts, with portions of these being saved in SRAM or DRAM while power is on and the counts also being periodically flushed to the non-volatile memory (such as NAND memory). The two counters can be bounded by different read disturb thresholds, such as can be based on device qualification data. The boundary WL counter is the special moving counter for the open/boundary wordlines and cumulative WL counter tracks overall reads fall into the open block.

For example, a block may be composed of 10 pages, with 3 pages written and 7 pages unwritten, so that the third page is the boundary between the written pages and the unwritten pages. In the present example, when reads are performed to the third page, the boundary WL counter in incremented. In this regard, reads for a respective block may be monitored, either for reads to the entire block (as represented by the value of the cumulative counter) or for reads to a sub-part of the block (as represented by the value of the boundary WL counter).

For example, a counter in an open block may be allocated and tracked (with n is the wordline currently being read; n−1 is the previous wordline and n+1 is the next), with Counter#1 for the boundary WL read count and Counter#2 for the cumulative read count. In this example, a die has two planes, P0 and P1, for the same die along the same wordline; however, dies with different numbers of planes are contemplated in different embodiments. In the event that the read is on one of the closed wordlines, the cumulative count for all wordline reads of Counter #2 is incremented from, in this example, 1000 to 1001. As the read is not on the boundary, the boundary counter Counter #1 stays the same.

For the reads that stress the boundary wordlines in the open block, a moving counter may be used to track the number of boundary wordline reads because an open block can be written to, so that the boundary wordlines in open blocks can change. To take care of a relatively worse case, the moving counter can keep incrementing if any read hits what is, at the time of the read, the boundary wordline. The counter value can be reset after the new, de-rated threshold is determined. Continuing the example, the boundary and cumulative counter values are respectively Counter #1=500 and Counter #2=1000. A page (or pages) of data is then written, so that the boundary moves down one wordline, so that what was the unwritten labelled as n+1 on the left is now the boundary wordline n on the right. The new boundary wordline is then read, so both the boundary and cumulative counters are incremented to Counter #1=501 and Counter #2=1001.

The definition of the boundary may also be broader than the last written wordline and include a set of wordlines in the near neighborhood of the last written wordline. For differing types of memory configurations (both in terms of structures and the number of states per cell), the definition of the boundary—and the number of pages involved—may vary. When the boundary counter is more general than for just the written last wordline in the write sequence, a weighting can be applied based on the different type of boundaries: for example, the “last wordline minus 1” could be weighted less than the last wordline.

An open block read refresh can then be triggered by either of the following two conditions:

If boundary WL read count>Boundary WL RD threshold;

If cumulative WL read count>Cumulative WL RD threshold.

In one embodiment, the two counts have different thresholds, where the threshold values may be fixed or variable. If a block is flagged for read scrub copy, the block relocation will be scheduled. After the block relocation, the risky block will be erased and the block erase will reset the counter values.

The number of reads for the counter(s) may be stored in the memory device. As one example, the number of reads may be stored in memory allocated for use by the memory device controller (e.g., volatile or non-volatile memory for use by the memory device controller). As another example, the number of reads may be stored in memory allocated for storage of host data (e.g., data sent from a host device for storage in non-volatile memory).

In one embodiment, the number of reads is stored in volatile memory (such as RAM) allocated for use by the memory device controller. In a more specific embodiment, the memory device controller may maintain a respective number of reads for one, some, or all of the blocks of non-volatile memory in the memory device. The respective number of reads may be correlated to a respective block identifier and stored in a table (or other type of data structure) in RAM or other type of volatile memory.

The values for the number of reads, stored in volatile memory, may be periodically flushed to, backed up, or stored in non-volatile memory. One example is to store the value for the number of reads at predetermined times (e.g., every 1 second, store the respective number of reads for each block of the non-volatile memory). Another example is to determine the overall accumulated counter for reads in all of the blocks of memory, and store the value of reads for each block of the non-volatile memory when the overall accumulated counter exceeds a threshold.

In one embodiment, the value(s) of the counter(s) for monitoring one or more sections of memory may be saved to non-volatile memory dependent on the monitored section(s) of memory. In a more specific embodiment, the trigger to determine whether to save the value of the read counter for a respective section of memory (e.g., a respective block) may be based, at least in part, on a disturb effect of the read, with the read disturb effect being based on one or more aspects of the respective section of memory.

In particular, one or more aspects of the monitored section of the memory (such as the block) may be used to determine a disturb effect of the read. Examples of aspects include any one, or both of the following: a status of the respective section of memory (e.g., whether the block is open or closed); a type of the respective section of memory (e.g., whether the cells in the block are single-level cells or multi-level cells and/or whether the block is for on-chip copy (OCC) or non-OCC); a determination as to where, within the block, the read occurred (e.g., whether the read occurred in a boundary WL). Thus, the aspect(s) may be used to weight the effect of the read disturb. The aspects listed are merely for illustration purposes. Other aspects are contemplated.

Based on the read disturb effect (using the one or more aspects of the monitored section of the memory), the memory device controller may determine whether to save the value(s) of the counter(s) to non-volatile memory. In particular, the memory device controller may determine the read disturb effect for a single block (using the aspect(s) for the single block), for multiple blocks (using the aspect(s) for the blocks that have been read), or for all of the blocks of memory (using the aspect(s) for the blocks that have been read). For example, the memory device controller may monitor the determined read disturb effect for the block(s) using an adaptive counter, discussed in more detail below. The value of the adaptive counter (e.g., the value associated with the counter or the threshold against which the value is compared) may be indicative of the read disturb effect across one, some, or all of the blocks in the memory device. When the value of the adaptive counter is greater than the threshold, the memory device controller saves the value of the counters (such as values of the cumulative counters and/or the values of the boundary WL counters) to non-volatile memory.

As discussed above, various activities within the memory, such as reads to respective blocks, may be monitored. In this regard, though the below discussion focuses on saving values associated with read counters, any data structure (such as any type of counter) associated with monitoring activity within the memory (separate from monitoring reads) may be likewise applied.

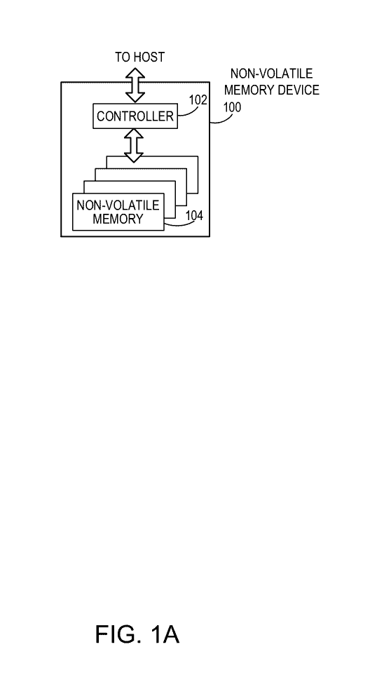

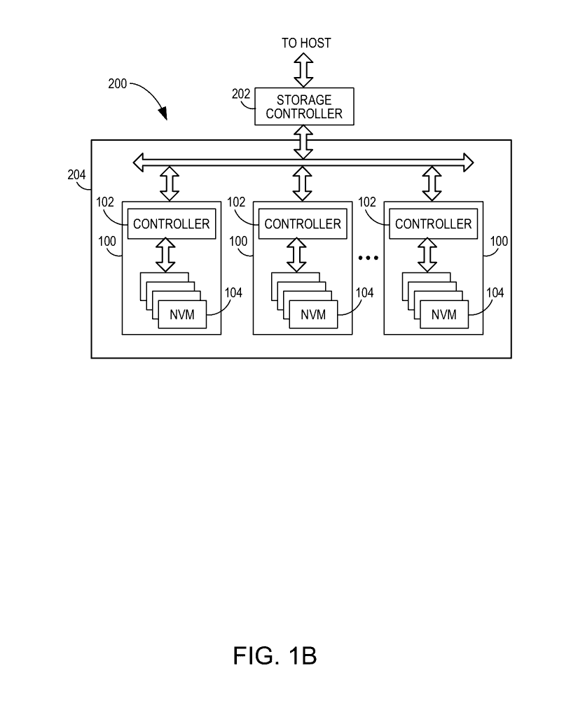

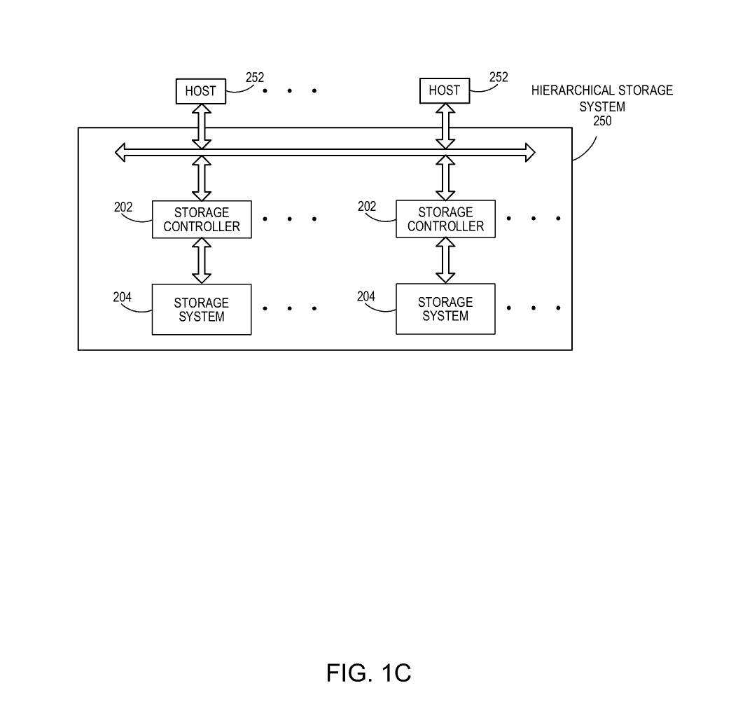

Referring to the figures, FIG. 1A is a block diagram illustrating a non-volatile memory device. The non-volatile memory device 100 includes a controller 102 and non-volatile memory that may be composed of one or more non-volatile memory die 104. The non-volatile memory die may comprise one or more memory integrated circuit chips. One or both of the controller 102 and non-volatile memory die 104 may use a regulated voltage. As used herein, the term die refers to the set of non-volatile memory cells, and associated circuitry for managing the physical operation of those non-volatile memory cells, that are formed on a single semiconductor substrate. Controller 102 interfaces with a host device and transmits command sequences for read, program (e.g., write), and erase operations to non-volatile memory die 104.

The controller 102 can take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. These examples of the controller 102 are not exhaustive and other forms for performing controller functionality are contemplated. The controller 102 can be configured with hardware and/or firmware to perform the various functions described below and shown in the flow diagrams. For example, the hardware and/or firmware may be configured for analysis as to whether to save the value of the read counter to non-volatile memory, as discussed in more detail below. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

One type of controller 102 is a flash memory controller. As used herein, a flash memory controller is a device that manages data stored on flash memory and communicates with a host device, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host device needs to read data from or write data to the flash memory, it will communicate with the flash memory controller. If the host device provides a logical address to which data is to be read/written, the flash memory controller can convert the logical address received from the host device to a physical address in the flash memory. (Alternatively, the host device can provide the physical address). The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. One example of non-volatile memory die 104 may comprise a memory integrated circuit chip. The memory cells can take the form of solid-state (e.g., flash) memory cells and can be one-time programmable, few-time programmable, or many-time programmable. As discussed above, the memory cells can also be single-level cells (SLC), multiple-level cells (MLC), triple-level cells (TLC), quadruple-level cells (QLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, memory device 100 may be a card based system, such as a secure digital (SD) or a micro secure digital (micro-SD) card. In an alternate embodiment, memory device 100 may be part of an embedded memory system.

Although in the example illustrated in FIG. 1A non-volatile memory device 100 includes a single channel between controller 102 and non-volatile memory die 104, the subject matter described herein is not limited to having a single memory channel. For example, in some NAND memory system architectures such as illustrated in FIGS. 1B-C, 2, 4, 8 or more NAND channels may exist between the controller and the NAND memory system, depending on controller capabilities. In any of the embodiments described herein, more than a single channel may exist between the controller and the memory die, even if a single channel is shown in the drawings.

FIG. 1B illustrates storage circuitry 200 that includes plural non-volatile memory devices 100. As such, storage circuitry 200 may include a storage controller 202 that interfaces with a host device and with storage system 204, which includes a plurality of non-volatile memory devices 100. The interface between storage controller 202 and non-volatile memory devices 100 may be a bus interface, such as a serial advanced technology attachment (SATA) or peripheral component interface express (PCIe) interface. Storage circuitry 200, in one embodiment, may be a solid state drive (SSD), such as found in portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the hierarchical storage system via a bus interface. In one embodiment, the bus interface may be a non-volatile memory express (NVMe) or a fiber channel over Ethernet (FCoE) interface. In one embodiment, the system illustrated in FIG. 1C may be a rack mountable mass storage system that is accessible by multiple host computers, such as would be found in a data center or other location where mass storage is needed.

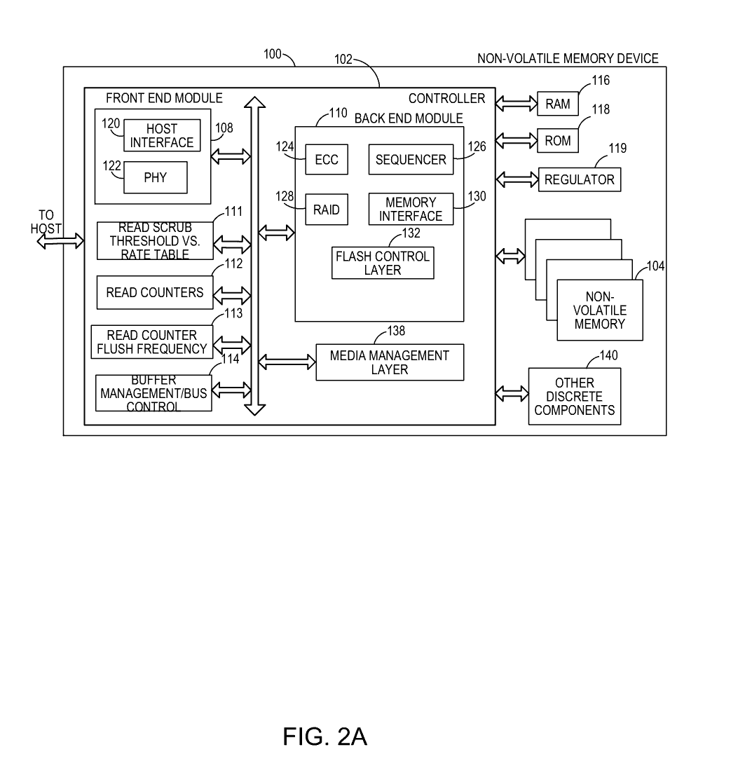

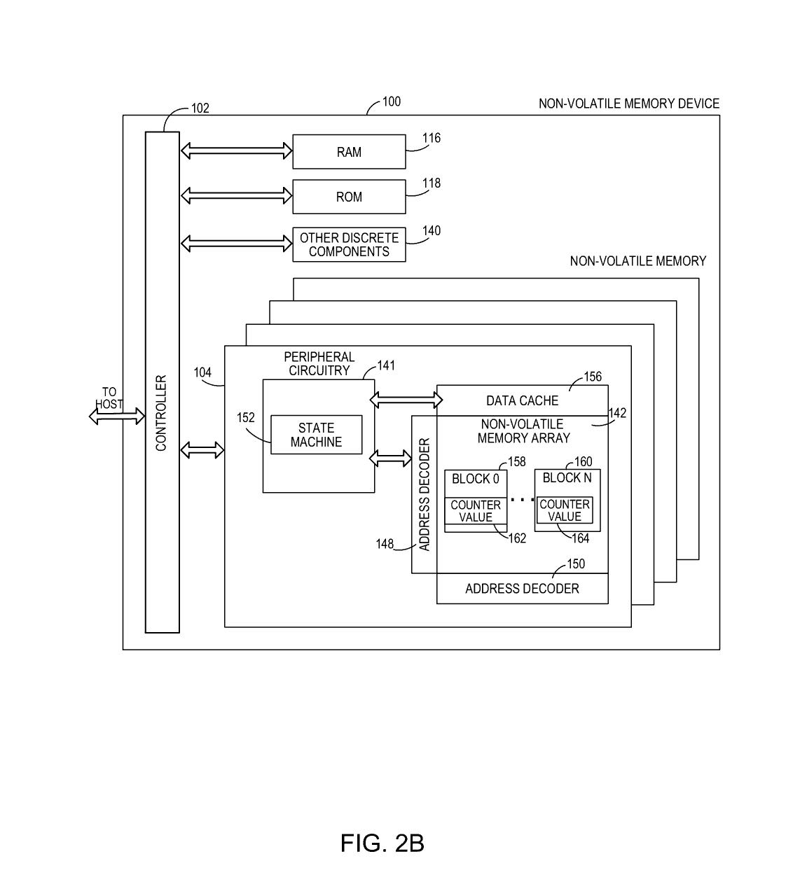

FIG. 2A is a block diagram illustrating exemplary components of controller 102 in more detail. Controller 102 includes front end circuitry 108 that interfaces with a host device, back end circuitry 110 that interfaces with the one or more non-volatile memory die 104, and various other circuitry that perform functions which will now be described in detail.

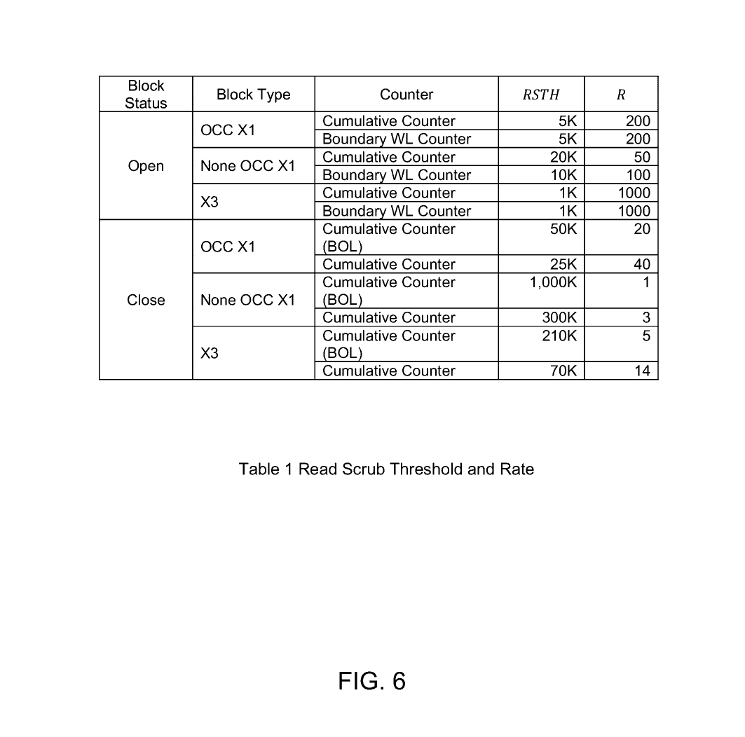

Circuitry of the controller 102 may include read scrub threshold vs. rate table circuitry 111, read counters circuitry 112, and read counter frequency flush circuitry 113. As explained in more detail below with respect to FIG. 6, read scrub threshold vs. rate table circuitry 111 may be indicative of an effect of a read disturb and may be implemented using a table, or the like, that correlates read scrub threshold (RSTH) vs. rate (R). Read scrub threshold vs. rate table circuitry 111 may be implemented in non-volatile memory assigned to controller 102. Read counter circuitry 112 comprises the circuitry to manage the read counters for the blocks in non-volatile memory 102 (e.g., the logic for identifying a read to a respective block, and for incrementing the counter for the respective block) and to store the values for the read counters (e.g., the volatile memory used to store the values for the read counters). As discussed above, various counters, such as the cumulative counters, the boundary WL counters, and the adaptive counter may be used. Read counter circuitry 112 may manage the values for the cumulative counters, boundary WL counters, and the adaptive counter. Read counter flush frequency circuitry 113 comprises the circuitry to determine whether to store the value(s) of the read counters from volatile memory to non-volatile memory. As discussed in more detail below, saving (e.g., flushing) of the value(s) of the read counters may be triggered based on one or more conditions, including without limitation: a characteristic of the block to which the read counter is assigned (e.g., whether the block is open or closed, whether the block is SLC or MLC, and/or whether the block has OCC); and a characteristic of the read itself (e.g., whether the read is to a boundary WL). In one embodiment, the OCC block is a block in which host data is stored, and a non-OCC block is a block in which firmware internal control data is stored. Thus, in this embodiment, non-OCC blocks are considered a focus against the read disturb problem. In this regard, the read counter flush frequency circuitry 113 may analyze the one or more conditions in order to determine whether to save the value(s) to non-volatile memory. As discussed in more detail below, in one embodiment, the read counter flush frequency circuitry 113 may analyze the adaptive counter in order to determine whether to flush the values of the cumulative counters and the boundary WL counters.

Referring again to circuitry of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller. Further, in some implementations, the controller 102, RAM 116, and ROM 118 may be located on separate semiconductor die.

Front end circuitry 108 includes a host interface 120 and a physical layer interface (PHY) 122 that provide the electrical interface with the host device or next level storage controller. The choice of the type of host interface 120 can depend on the type of memory being used. Examples of host interfaces 120 include, but are not limited to, SATA, SATA Express, SAS, Fibre Channel, USB, PCIe, eMMC I/F, and NVMe. The host interface 120 typically facilitates transfer for data, control signals, and timing signals.

Back end circuitry 110 includes an error correction controller (ECC) engine 124 that encodes the data bytes received from the host device, and decodes and error corrects the data bytes read from the non-volatile memory. A command sequencer 126 generates command sequences, such as program and erase command sequences, to be transmitted to non-volatile memory die 104. RAID (Redundant Array of Independent Drives) circuitry 128 manages generation of RAID parity and recovery of failed data. The RAID parity may be used as an additional level of integrity protection for the data being written into the non-volatile memory device 100. In some cases, the RAID circuitry 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end circuitry 110.

Additional components of system 100 illustrated in FIG. 2A include media management layer 138, which performs wear leveling of memory cells of non-volatile memory die 104. System 100 also includes other discrete components 140, such as external electrical interfaces, external RAM, resistors, capacitors, or other components that may interface with controller 102.

In alternative embodiments, one or more of the physical layer interface 122, RAID circuitry 128, media management layer 138 and buffer management/bus controller 114 are optional components that are not necessary in the controller 102.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Peripheral circuitry 141 includes a state machine 152 that provides status information to controller 102.

Non-volatile memory die 104 further includes address decoders 148, 150 for addressing within non-volatile memory array 142, and a data cache 156 that caches data. As discussed above, non-volatile memory array 142 may be composed of multiple blocks, represented as block 0 (158) to block N (160). Different numbers of blocks within non-volatile memory array 142 are contemplated. FIG. 2B further illustrates counter value 162, 164. As discussed above, the values for the read counters may be stored from volatile memory to non-volatile memory. In one embodiment, the counter value may be stored in the respective block to which the counter is assigned. In particular, the value for read counter 0 may be assigned for reads to block 0 (158). In response to determining to store the value for read counter 0 to non-volatile memory, the read counter flush frequency circuitry 113 may store the value within block 0 (158), as represented by counter value 162. In an alternative embodiment, the value for a read counter may be stored in a block different from the respective block to which the counter is assigned.

Though FIG. 2B illustrates a single value stored in a respective block, more than one counter value may be stored in a respective block. For example, multiple counters may monitor a respective section of memory. In particular, block 0 may be an open block. In this regard, multiple counters, such as a cumulative counter and a boundary WL counter, may be used. When the memory device controller 102 determines to save the values of the cumulative counter and the boundary WL counter to non-volatile memory (such as block 0), the values for both the cumulative counter and the boundary WL counter may be saved to block 0.

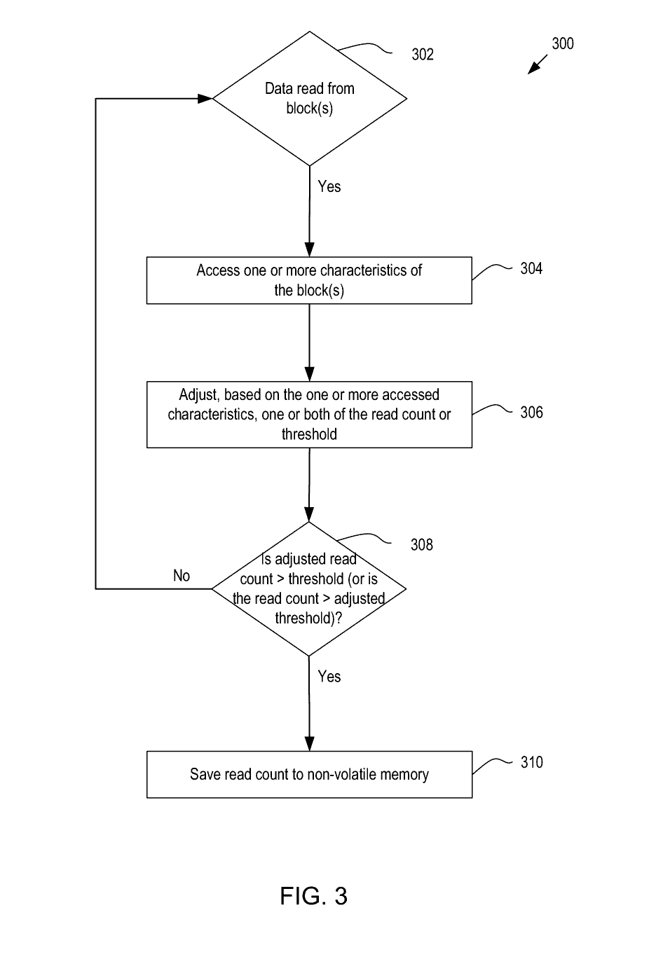

As discussed above, the trigger to determine whether to save the value(s) of the counters may be based on a disturb effect of the read (such as based on one or more aspects of the section of memory subject to the read). FIG. 3 is an example of this, illustrating a first flow chart 300 for determining whether to save the read count for one, some, or all of the counters to non-volatile memory. At 302, it is determined whether data is read from one or more blocks in non-volatile memory. In response to determining that data has been read from the one or more blocks, at 304, one or more characteristics of the read block(s) are accessed. As discussed above, characteristics, separate from the time elapsed since the last flush to non-volatile memory or separate from the overall accumulated counter, may determine whether to flush one or more of the values of the counters to non-volatile memory. The characteristics may comprise a characteristic of the block to which the read counter is assigned and/or a type of the counter. At 306, one or both of the read count or the threshold are adjusted based on the accessed characteristics. At 308, a comparison is made. For example, the adjusted read count is compared with a predetermined threshold. As another example, the read count is compared with an adjusted threshold. If the comparison is greater, at 310, the read count is saved to non-volatile memory. If the comparison is less, flow diagram 300 loops back to 302.

Thus, based on the accessed characteristics, controller 102 may determine whether to flush one or more of the values of the counters to non-volatile memory. In particular, controller 102 may use the accessed characteristics in order to determine a more accurate disturb effect of the read, and in turn to determine whether to flush the value(s) to non-volatile memory.

In one embodiment, in order to determine whether to flush to non-volatile memory, controller 102 may compare the value for the adaptive counter with a static threshold. As discussed in more detail below, the value of the adaptive counter may be adjusted based on the accessed characteristic(s) that is more indicative of the disturbance effect of the read.

Further, multiple counters may be used to track the reads, as discussed above. In one embodiment, a cumulative counter and a boundary WL counter may be used. For example, the value stored for the cumulative counter may be indicative of a cumulative number of reads for a respective block (without accounting for the type of block). In the event that the respective block is an open block, a boundary WL counter may be used to track reads to the boundary WL.

As discussed in more detail below, the adaptive counter may examine one or multiple reads (as tracked by one or multiple counters) to determine a more accurate read disturb effect. In particular, a single read to a boundary page of an open block affects the cumulative counter for the open block and affects the boundary WL counter for the open block. In this regard, the cumulative counter may be indicative of one type of read disturb effect, whereas the boundary WL counter may be indicative of a different type of read disturb effect. As discussed below, reading from a boundary WL may have a greater read disturb effect than a read to a closed block. Thus, in one embodiment, the value of the adaptive counter may be adjusted by analyzing one or multiple types of reads. In a more specific embodiment, when the read is to the boundary page of the open block, the value of the adaptive counter may be adjusted based on the read disturb effect due to reading of the boundary WL (rather than to the effect of the read as indicated by the cumulative counter). The adaptive counter may thus take into account a read disturbance assessment, based on the adaptive read counter, so that frequency f_{rc} may adapt to different access patterns and be changed at runtime accordingly.

For example, flushing may be triggered by the following condition:

If (adaptive counter)>(predefined threshold),

with the adaptive counter being calculated with the rated read counter by the following equation:

$$( adaptive counter ) = {\sum }_{i}^{number of counter types} {R}_{i} \times {C}_{i}$$

where Cᵢ is accumulated read counter and Rᵢ is indicative of a disturb effect for the read. In one embodiment, Rᵢ is a rating multiplicative inverse of normalized RSTH and calculated by following equation:

$${R}_{i} = \frac{{RSTH}_{base}}{{RSTH}_{i}}$$

with RSTH_{base} being the highest threshold among RSTHs and constant. As illustrated in the example of FIG. 6, for open blocks, the read disturb effect from reading the boundary WL (as tracked by the boundary WL counter) is greater than the read disturb effect from generally reading from a block (as tracked by the cumulative counter).

Examples of R, RSTH and RSTH_{base} values are illustrated in the table shown in FIG. 6. The highest RSTH is 1,000K, and thus may be used as RSTH_{base}. Further, for an open block, with block type OCC ×1 (e.g., SLC), and a cumulative counter, RSTH is 5K and R is 200 (1,000K/5K). In this regard, FIG. 6 illustrates examples of adjustment factors in which to adjust the read activity based on one or more characteristics of the respective block.

In operation, when a read is registered to a respective block, the characteristics of the block and the type of counter are examined in order to determine a more accurate effect of the read. For example, host data is read from an “open” block that is block type of OCC X1. Given this, the rate R is 200, with the adaptive counter incremented by 200. In effect, this read is, relatively speaking, the equivalent of 200 reads from a read disturb perspective of a host data read of a “closed” block that is block type none OCC X1 for a cumulative counter (beginning of life (BOL)). In one embodiment, one measure of the lifetime of a respective block is determined by number of program/erase (P/E) cycles for the respective block. In other words, the R value is indicative of a more accurate effect of the read. Whereas in the prior art, a single read would increment the read counter by “1”, controller 102 analyzes the characteristics of the block and/or the characteristics of the counter to determine the R value, and use the R value in order to increment the counter to a value greater than “1”.

The following is another example of operation. Prior to the read, the adaptive counter=2760 and the predefined threshold=3000 (i.e., the threshold at which the values of the counters are saved in non-volatile memory). Therefore, the value of the adaptive counter is less than the predefined threshold so that the value(s) of the counter(s) are not saved to non-volatile memory. A read of host data from an “open” block (not boundary wordline). The read may trigger modification of the value(s) of one or more counters. In the example of multiple counters, the cumulative counter of the block is incremented by 1. Further, the RSTH=5K and R=200. Thus, the adaptive counter is incremented by 200, with the adaptive counter=2960. Since the value of the adaptive counter is still less than the predefined threshold, the value(s) of the counter(s) are not saved to non-volatile memory.

Continuing with the example, the next read is a read of control data on an open Block (not boundary wordline). Again, the value of the cumulative counter for the respective block is incremented by 1. The characteristics of the block and the counter are analyzed, with the RSTH=20K, and R=50. Thus, the adaptive counter is incremented by 50 so that the adaptive counter=3010. Since the adaptive counter is now greater than the predefined threshold of 3000, the values of the counters is flushed.

Thus, the value of the adaptive counter is different from a counter that simply totals the reads for multiple blocks. Instead, the value of the adaptive counter may be considered a weighted counter, whereby the reads are weighted to give an indication of a true effect of the read disturb. For example, when a read for a respective block is performed, the value of the adaptive counter is not simply incremented by “1”. Instead, using the aspect(s) of the respective block, the value of the adaptive counter is incremented to reflect the effect of the read.

In the example above, the read count value is adjusted based on the characteristics. Alternatively, the threshold may be adjusted based on the accessed characteristics. In one example, the threshold may be reduced based on the accessed characteristic s. In particular, the threshold may be reduced more for a read that results in a larger read disturb effect than a read that results in a smaller read disturb effect. In either embodiment (adjusting the read count value or adjusting the threshold), the accessed characteristics may be used to adjust one or both of the read count value(s) and the threshold to more accurately reflect the disturb effect of the read, and in turn to determine whether to flush the value(s) to non-volatile memory. In this way, using the accessed characteristics to better assess the effect of the disturb effect of the read, the read counter data structures may be flushed to the flash memory periodically with frequency f_{rc}. The appropriate frequency f_{rc} may be selected as not to lose values of the read counters while reducing or minimizing the impact of write amplification and write endurance.

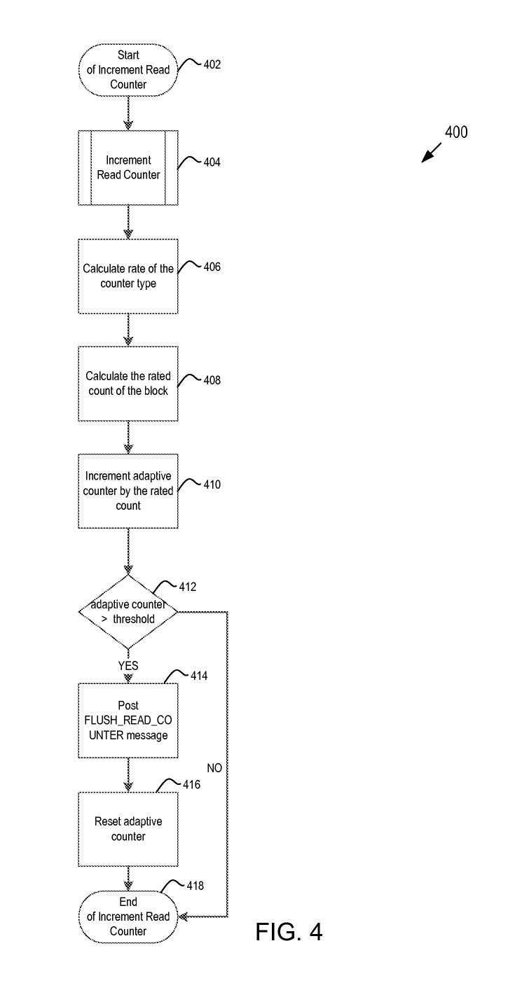

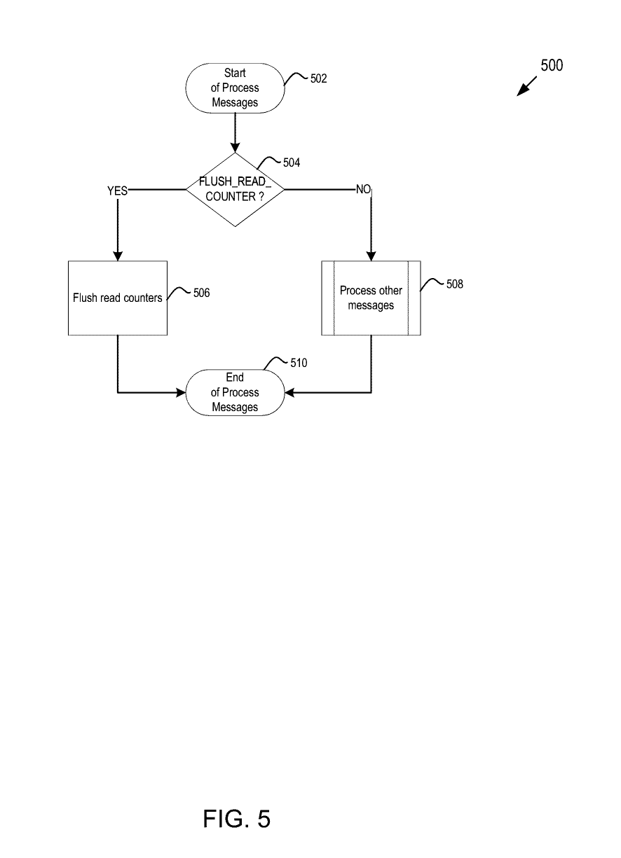

FIG. 4 illustrates a second flow chart 400 for determining whether to save the read count to non-volatile memory. At 402, the increment read counter process is started. In one embodiment, the trigger to start the increment read counter process is determining that a read has occurred. At 404, the read counter is incremented. At 406, the rate of the counter type is calculated. As discussed above, one example of the rate of the counter type is RSTH. At 408, the rated count of the block is calculated. As discussed above, one example of the rated count is R. At 410, the adaptive counter is incremented by the rated count. As discussed above, the adaptive counter may be incremented by the R. At 412, the value of the adaptive counter is compared with the threshold. If the value of the adaptive counter is greater than the threshold, at 414, a FLUSH_READ_COUNTER message is posted. FIG. 5 discusses the processing of posting a FLUSH_READ_COUNTER message. At 416, the adaptive counter is reset to zero. If the value of the adaptive counter is less than or equal to the threshold, flow chart 400 goes to the end of increment read counter process at 418.

FIG. 5 illustrates a flow chart 500 for determining whether to process a flush read counter message. At 502, the processing of messages is started. In one embodiment, the processing of messages may be performed at predetermined intervals, such as during idle times of controller 102. At 504, the value of the FLUSH_READ_COUNTER is analyzed. If the FLUSH_READ_COUNTER is set (meaning that a flush read command is pending), at 506, the read counters are flushed to non-volatile memory. As discussed above, the read counters may be assigned to a respective section of non-volatile memory. In one embodiment, the value of the specific read counter may be saved to the respective section of non-volatile memory that the specific read counter is assigned to. If the FLUSH_READ_COUNTER is not set (meaning that a flush read command is not pending), at 508, other messages are processed. After which, flow chart 500 goes to the end of processing message at 510.

In the present application, semiconductor memory devices such as those described in the present application may include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

In one embodiment, a module may be used and may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Further, the methods, devices, processing, circuitry, and logic described herein may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

Thus, associated circuitry may be used for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for determining whether to save a value for a counter to non-volatile memory, the method comprising:
performing an activity on a section of memory;
incrementing the value of the counter, the value of the counter indicative of the activity in the section of memory;
accessing one or more characteristics of the section of memory;
determining, based on the one or more characteristics accessed, whether to save the value of the counter to non-volatile memory; and
in response to determining to save the value of the counter to non-volatile memory, saving the value of the counter to non-volatile memory.

2. The method of claim 1, wherein determining, based on the one or more characteristics accessed, whether to save the value of the counter to non-volatile memory comprises:
determining, based on the one or more characteristics accessed, an effect of the activity on the section of memory; and
determining, based on the effect, whether to save the value of the counter to non-volatile memory.

3. The method of claim 2, wherein determining, based on the one or more characteristics accessed, the effect of the activity on the section of memory comprises:
accessing, based on the one or more characteristics accessed, an activity adjustment factor, the activity adjustment factor indicative of the effect of the activity on the section of memory.

4. The method of claim 1, wherein the section of memory comprises a block of non-volatile memory in a memory device.

5. The method of claim 4, wherein the activity comprises performing a read in the block.

6. The method of claim 5, wherein the one or more characteristics of the section of the memory comprises whether the block is open for writing data thereto or closed for writing data thereto.

7. The method of claim 5, wherein the one or more characteristics of the section of memory comprises whether the block of memory is single level cell (SLC) memory or non-SLC memory.

8. The method of claim 5, wherein the one or more characteristics of the section of the memory comprises whether the read was performed at a boundary wordline (WL) within the block.

9. The method of claim 1, wherein the counter comprises a first counter; and
wherein determining, based on the one or more characteristics accessed, whether to save the value of the counter to non-volatile memory comprises:
adjusting one or both of a value of an adaptive counter or a threshold based on the adjustment factor, the threshold indicative of a value at or above which to save the value of the first counter to non-volatile memory; and
determining to save the value of the first counter to non-volatile memory in response to determining that the value of the adaptive counter is greater than or equal to the threshold.

10. The method of claim 9, wherein a respective block is subject to a single read; and
wherein adjusting one or both of the value of the adaptive counter and the threshold comprises weighting the single read such that the value of the adaptive counter is incremented by more than 1.

11. The method of claim 9, wherein each of a plurality of blocks in a memory device includes a respective counter;
wherein the adaptive counter is configured to track the effect of the reads on the plurality of blocks in a memory device; and
wherein, in response to determining that the value of the adaptive counter is greater than the threshold, the values of each respective counter is saved to the non-volatile memory.

12. The method of claim 1, wherein the activity performed is on a respective memory block;
wherein the value of the counter is indicative of reads to the respective memory block; and
wherein the value of the counter is saved to the respective memory block.

13. A memory device comprising:
read counter circuitry configured to count reads in respective sections of memory in the memory device;
characteristic storage circuitry configured to store one or more characteristics for the respective sections of memory; and
read counter storage circuitry configured to determine, based on the one or more characteristics for the respective sections of memory, whether to store in non-volatile memory the counts of the reads in the respective sections of memory.

14. The memory device of claim 13, wherein the respective sections of memory comprises respective blocks of memory.

15. The memory device of claim 13, wherein the one or more characteristics for the respective sections of memory comprises whether the respective sections of memory are open for writing data to the block of memory or closed for writing data.

16. The memory device of claim 13, wherein the one or more characteristics for the respective sections of memory comprises whether the block of memory is single level cell (SLC) memory or non-SLC memory.

17. The memory device of claim 13, wherein the one or more characteristics for the respective sections of memory comprises whether the read was performed at a boundary wordline (WL) within the block of memory.

18. The memory device of claim 13, wherein the read counter storage circuitry is configured to:
determine an effect, based on the one or more characteristics for the respective sections of memory, of the reads to the respective sections of memory; and
determine, based on the effect, whether to store in non-volatile memory the counts of the reads.

19. The memory device of claim 18, wherein the read counter storage circuitry is configured to control a value for an adaptive counter, wherein the value for the adaptive counter is indicative of the effect of the reads to the respective sections of memory.

20. The memory device of claim 19, wherein, responsive to a single read to the respective section of memory, the read counter storage circuitry is configured to weight the single read such that the value of the adaptive counter is incremented by more than 1.

21. The memory device of claim 20, wherein the memory device includes a plurality of blocks;
wherein the read counter circuitry is configured, for each respective block, to control a cumulative counter indicative of a number of reads to the respective block since a last erase of the respective block;
wherein, for each respective open block, the read counter circuitry is further configured to control a boundary wordline (WL) counter indicative of reads to a boundary WL in the respective open block; and
wherein the read counter storage circuitry is configured, in response to incrementing of one or both of the cumulative counter or the boundary WL counter, to determine whether to store the counts of the reads for the cumulative counters and the boundary WL counters.

22. The memory device of claim 21, wherein the read counter storage circuitry is configured, in response to incrementing of the boundary WL counter, to adjust the value of the adaptive counter.
